(19) United States
(12) Patent Application Publication
(10) Pub. No.: US 2014/0113252 A1
(43) Pub. Date: Apr. 24, 2014

(54) Ankylos Attachment Complex (AAC)

(71) Applicant: William Y.S. Hung, Claremont, CA (US)

(72) Inventor: William Y.S. Hung, Claremont, CA (US)

(21) Appl. No.: 13/659,283

(22) Filed: Oct. 24, 2012

(51) Int. Cl. A61C 8/00

(52) U.S. Cl. CPC A61C 8/0001
USPC 433/201.1

(57) ABSTRACT

An ankylos attachment (AA) comprising a transitional adapter at coronal end for serving as an impression coping, temporary/permanent attachment. A threaded retentive shank (TRS) comprises a bolt which is designed to insert through the AA into the dental implant.

The new design of the AAC is compelling because it can reduce cost, improve patient comfort and reduce clinical chair time/treatment time. In addition, AAC can be utilized to facilitate CAD/CAM technique which can largely shorten the period of fabrication of dental restoration. As a result, the final restoration can be finished and delivered in a couple of hours comparing to six to twelve weeks when the restoration is done in traditional way.

### BACKGROUND OF THE PRESENT INVENTION

1. Field of Invention

The present invention relates to (1) an Ankylos Attachment (AA), particularly to the AA having (a) a transitional adapter and (b) an ankylos attachment body with interior (triangular, square, pentagonal or hexagonal) slots for a driver to place a dental implant and the AA simultaneously, (2) a Threaded Retentive Shank (TRS) for making an impression immediately after implant surgery.

2. Description of Related Arts

Traditionally, a dental implant is placed by implant driver. A healing period of four to six months is required for healing and osseointegration. However, the new dental implant protocol can include immediate placement and immediate loading. The treatment can be finished in a very short period of time. Many cases can be finished in a couple of hours, such as teeth in a hour. Therefore, the present invention of AAC is introduced for immediate final impression after dental implant placement to facilitate the making of final restoration. In addition, AAC can be utilized to facilitate a Computer-Aided Design and Computer-Aided Manufacturing (CAD/CAM) technique which can largely shorten the period of fabrication of dental restoration. In other words, the AAC can be scanned by a CAD/CAM scanner. The data can be transferred to a Computer Numerical Control (CNC) machine. As a result, the final restoration can be finished and delivered in a couple of hours.

Traditionally, the process takes six to twelve weeks to complete a dental restoration. With the assistance of the present invention and CAD/CAM technique, time and cost of making a final restoration can be reduced dramatically. By utilizing of the AAC, billions of dollars can be saved in dentistry, patient comfort can be gigantically improved and patient satisfaction enhanced.

The concept of CAD/CAM dentistry differs from conventional dentistry in that the prosthesis is typically bonded in place the same day, whereas conventional dental prosthesis such as crowns have temporaries placed for several weeks or months while a dental laboratory produces the restoration off-site. The patient returns weeks or months later, the temporary is removed, and then the laboratory made crown is then cemented or bonded in place. Because the CAD/CAM restoration can be finished in the same day, dentists are allowed to deliver final restoration in the same day.

The new design of the AAC is compelling because it can reduce cost, improve patient comfort and reduce clinical chair time/treatment time. The present invention which is a new design can be used as a transitional adapter, impression copping, provisional attachment and/or permanent attachment. In other word, a device can be used for four purposes. This new design includes an AA and a TRS. The TRS can be placed on the top of the newly designed AA to secure the AA immediately after the dental implant placed and impression can be made immediately after the dental implant surgery without waiting period to facilitate an immediate loading of restoration. Patients can receive the benefits of chewing function and esthetics, immediately after the dental implant surgery, without a waiting period of three to six months.

### SUMMARY OF THE PRESENT INVENTION

A main object of the present invention is to provide an AA which is cost effective and is less expensive.

Another object of the present invention is to provide an AA which reduces time of treatment (chair time).

Another object of the present invention is to provide an AA which reduces waiting period of treatment (three to six months).

Another object of the present invention is to provide an AA which improves scanning accuracy during application of CAD/CAM technique.

Another object of the present invention is to provide an AA which can improve clinical convenience. (It is difficult to seat impression copping immediately after the dental implant surgery due to bleeding)

Another object of the present invention is to provide an AA which can reduce office visits.

Another object of the present invention is to provide an AA which facilitates/speeds the process of immediate loading for function and esthetic reasons.

Another object of the present invention is to provide an AA which can increase patient comfort.

Another object of the present invention is to provide a TRS which can be used in an open-tray technique for making an immediate final impression.

Another object of the present invention is to provide a TRS which is cost effective and is less expensive.

Another object of the present invention is to provide a TRS which reduces time of treatment (chair time).

Another object of the present invention is to provide a TRS which can improve clinical convenience. (It is difficult to seat impression copping immediately after a dental implant surgery due to bleeding)

Another object of the present invention is to provide a TRS for making an impression immediately after the dental implant surgery.

Accordingly, in order to accomplish the above objects, the present invention provides an Ankylos Attachment (AA) and a threaded retentive shank (TRS), comprising:

a transitional adapter serves as an impression coping which consists of;

two small flat facets of the transitional adapter for providing an anti-rotation feature and increasing scanning accuracy of CAD/CAM technique;

a circumferential groove of the AA;

an ankylos attachment body; two lower flat facets of the ankylos attachment body for providing an anti-rotation feature and increasing scanning accuracy of CAD/CAM technique;

a shoulder of the ankylos attachment body;

a circumferential curvature of the ankylos attachment body;

a connector for internally connecting to the dental implant;

three engaging jaws protruded from the connector for inserting and engaging in the internal channel of the dental implant;

an interior hexagonal (or triangular, square, pentagonal) slot for receiving a hexagonal (or triangular, square, pentagonal) driver;

a cylinder head of the TRS;

a bolt of the TRS;

an apical end of the TRS for inserting into the AA and the dental implant; securing the AA and the dental implant;

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an ankylos attachment (AA) according to a preferred embodiment of the present invention.

FIG. 2 is a sectional view of the AA according to above preferred embodiment of the present invention.

FIG. 3 is a section view of the alternative mode of the AA according to above preferred embodiment of the present invention.

FIG. 4 is a perspective view of the threaded retentive shank (TRS) according to above preferred embodiment of the present invention.

FIG. 5 is an exploded view illustrating a dental implant, an AA and a TRS for securing the AA with the dental implant according to above preferred embodiment of the present invention.

FIG. 6 is a connected view illustrating a dental implant, an AA and a TRS for securing the AA with the dental implant according to above preferred embodiment of the present invention.

FIG. 7 is a sectional view of the TRS according to above preferred embodiment of the present invention.

FIG. 8 is a sectional view illustrating a dental implant, an AA and a TRS for securing the AA with the dental implant according to above preferred embodiment of the present invention.

### DETAILED DESCRIPTION OF THE PREFERRED EMBODIMENT

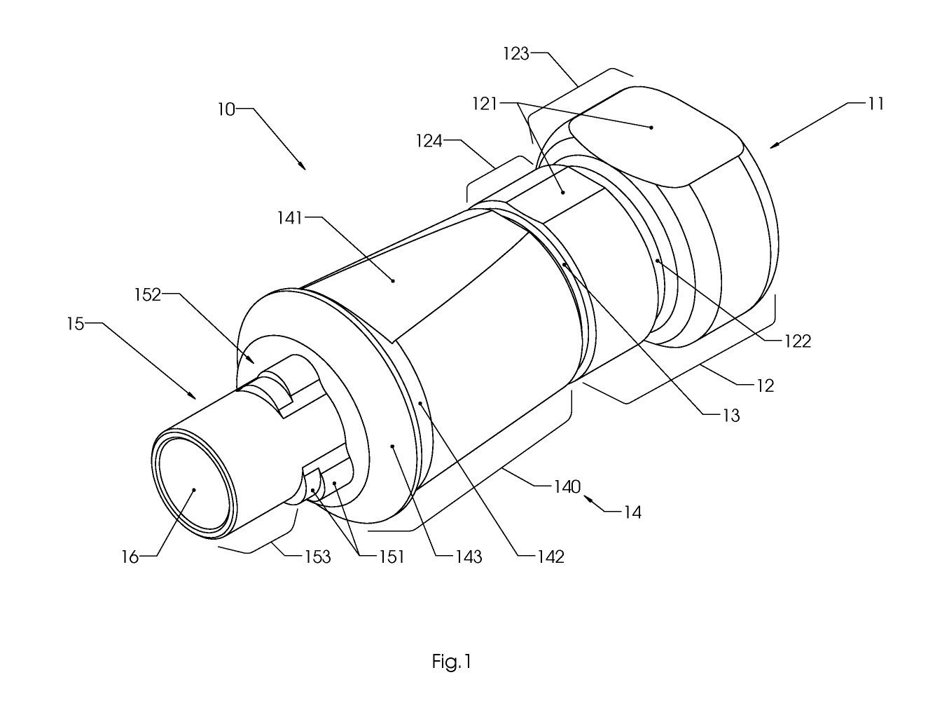

Referring to FIGS. 1 to 3 of the drawings, an ankylos attachment (AA) 10 according to a preferred embodiment of the present invention is illustrated, wherein the AA 10 comprises a transitional adapter 12, which is a metal collar at a coronal end 11 for receiving a driver, an ankylos attachment body 14 and a connector 15, which is a cylinder body 153, for internally connecting to a dental implant 70 through a threaded retentive shank (TRS) 90. The TRS 90 is used to secure the AA 10 and the dental implant 70 in an open-tray technique for making an immediate final impression.

The AA 10 is designed to facilitate a Computer-Aided Design and Computer-Aided Manufacturing (CAD/CAM) technique which can largely shorten the period of fabrication of dental restoration. In other words, the structure of the newly designed AA 10 can enhance scanning accuracy of a CAD/CAM scanner. The data can then be transferred to a Computer Numerical Control (CNC) machine. As a result, comparing to six to twelve weeks to complete a dental restoration in a traditional way, the final restoration can be finished and delivered in a couple of hours.

The ankylos attachment body 14 is located between transitional adapter 12 at coronal end and the connector 15 at apical end of AA. It comprised a tapered cylinder body 140, two lower flat facets 141, a shoulder 142 and a semi-circular tapered shoulder 143.

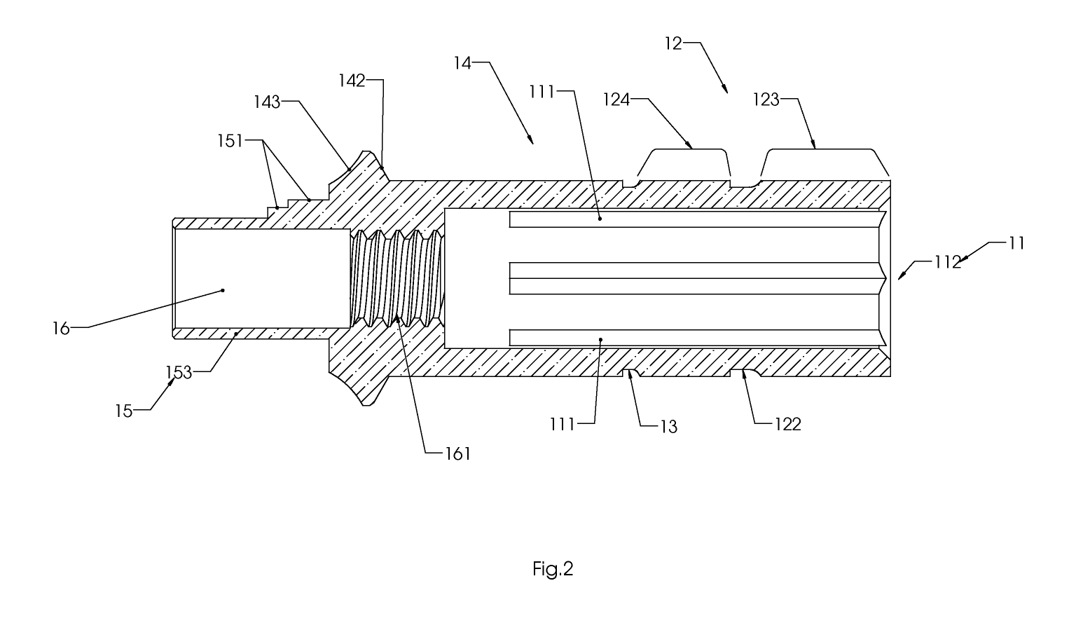

The transitional adapter 12 is a 2.5 to 7.5 mm in length coronal extension/metal collar delineated from the ankylos attachment body 14 separated by a circumferential groove 13. The transitional adapter 12 is designed to extend the AAC 10 with the addition of the threaded retentive shank (TRS) 90 to serve as an impression coping for open tray technique. The ankylos attachment body 14 can be used as a temporary/permanent attachment after the transitional adapter 12 is removed by a lab disk. The circumferential groove 13 is also designed to serve as an impression coping retentive feature. As illustrated in the cross sectional view of FIG. 2, a driven channel 112 of the coronal end 11 of the AA 10 is designed to receive a driver of corresponding shape.

The transitional adapter 12 has four upper flat facets 121, located at opposite sides of the transitional adapter 12, extending between the coronal end 11 and the circumferential groove 13. The ankylos attachment body 14 has a tapered cylinder body 140 with two lower flat facets 141, located at opposite sides of the ankylos attachment body 14, extending between the circumferential groove 13 and the shoulder 142. The tapered cylinder body has an angle of 3° to 5° to the longitudinal axis of AA. The upper flat facets 121 and the lower flat facets 141 enable the AA 10 to provide an anti-rotation feature for crown restoration.

The transitional adapter 12 is consisted of an upper portion 123, a lower portion 124 and a circumferential ditch 122. The upper portion 123 which is 2 mm to 4 mm in longitudinal length is located adjacent to the coronal end 11. The lower portion is located between the circumferential groove 13 and the circumferential ditch 122. The circumferential ditch 122 provides additional retention during impression.

The circumferential ditch 122 and the circumferential groove 13 not only perform as retentive features during impression, but also facilitate and enhance scanning accuracy while applying CAD/CAM technique by allowing scanning wave pass through both circumferential ditch 122 and the circumferential groove 13 easily.

Referring to FIG. 2, the AA 10 has a shoulder 142 on the ankylos attachment body 14. The shoulder 142 is designed to seat the margin of a crown restoration. A circumferential curvature 143 is apically located between shoulder 142 and connector 15, consisting a semi-circular surface extending inwardly from shoulder 142 to said connector 15, having an angle of 0° to 15° to the longitudinal axis of AA 10.

Referring to FIG. 1, the connector 15 is a male portion for internally connecting to the dental implant 70. The connector 15 is designed to be inserted into the dental implant 70 and the connector 15 fits into internal channel 71 of the dental implant 70. The diameter of the ankylos attachment body 14 and the connector 15 varies according to different sizes of the dental implant 70.

The connector 15 has three engaging jaws 152 protruding from the connector 15. Each of jaw 152 has two stairs 151. The three jaws 152 of the connector 15 are located between the circumferential curvature 143 and a cylinder body 153 of the connector 15 and are located 120° apart from each other and adapted to engage the internal channel 71 in the dental implant 70. The jaws 152 are designed to provide anti-rotation and friction to stabilize the AA 10 with the dental implant 70 by inserting into the female slots of the dental implant 70. When the engaging jaws 152 are inserted and engaged in the internal channel 71 of the dental implant 70, the position of the AA 10 is secured and the rotation of the AA 10 is prevented.

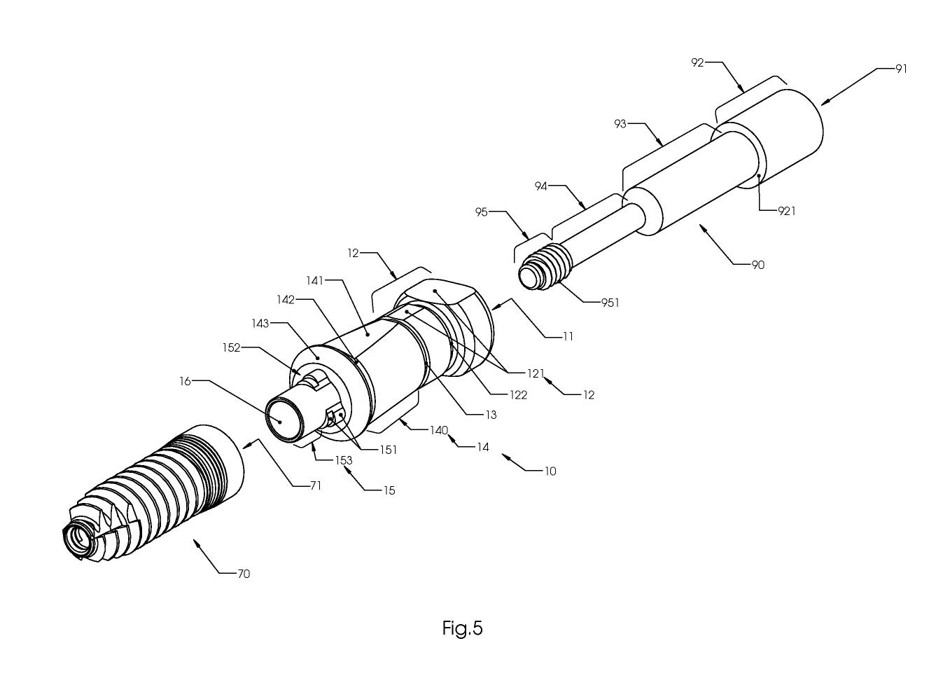

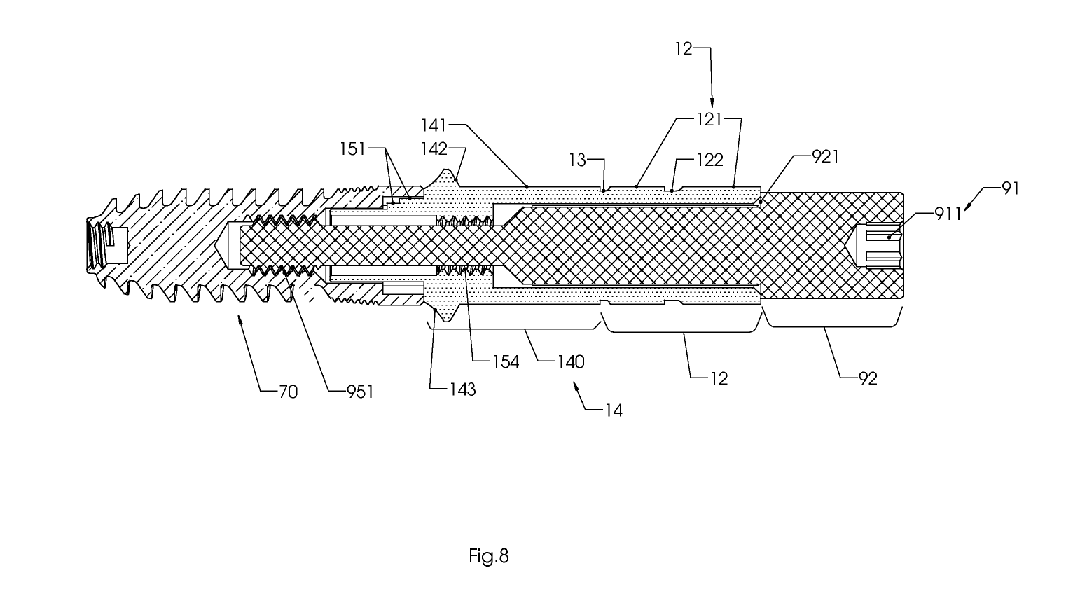

Referring to FIGS. 5 and 8, the AA 10 is fastened onto the dental implant 70 through the TRS 90. The AA has a through hole 16 communicating the internal channel 71 of the dental implant 70. The through hole 16 comprises an interior thread 161. The interior thread 161 is designed to allow the apical thread 951 of the TRS 90 to pass through and the apical thread 951 can then engage with the dental implant 70 and secure the AA 10 onto the dental implant 70.

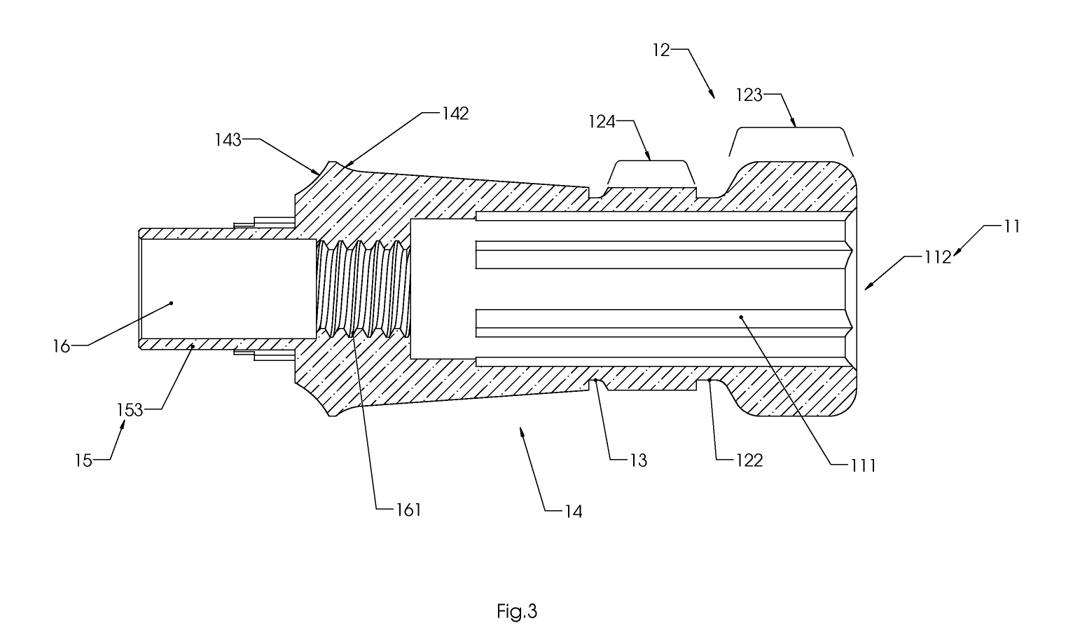

Referring to FIGS. 2 and 3 of the drawings, an interior hexagonal (triangular, square or pentagonal) slot 111 located at the internal wall of the AA 10 is designed to receive the hexagonal (triangular, square or pentagonal) driver. The length of the slot 111 can rang from 4.5 mm to 8.5 mm.

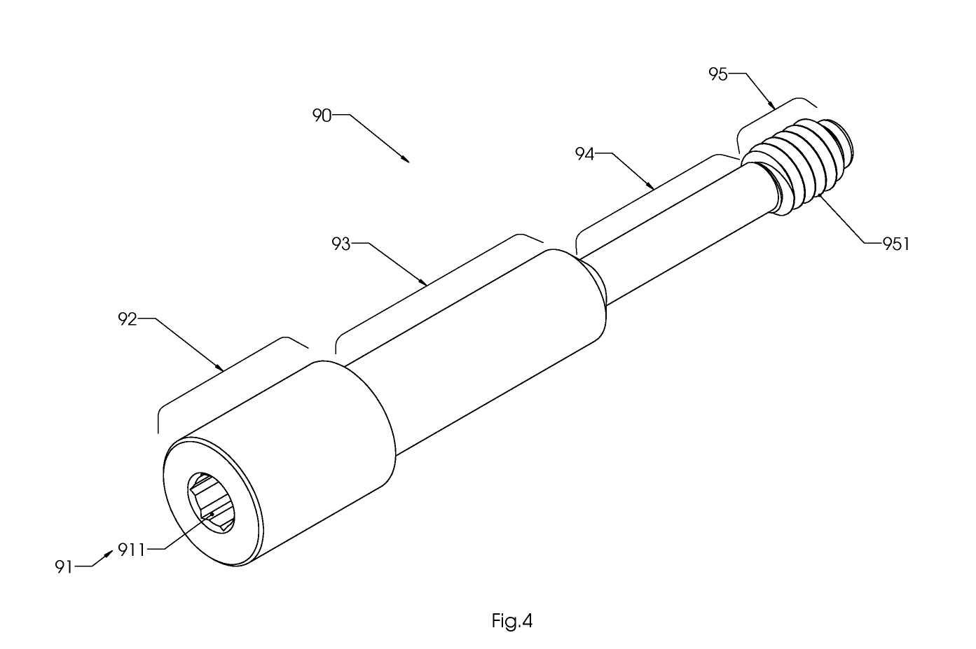

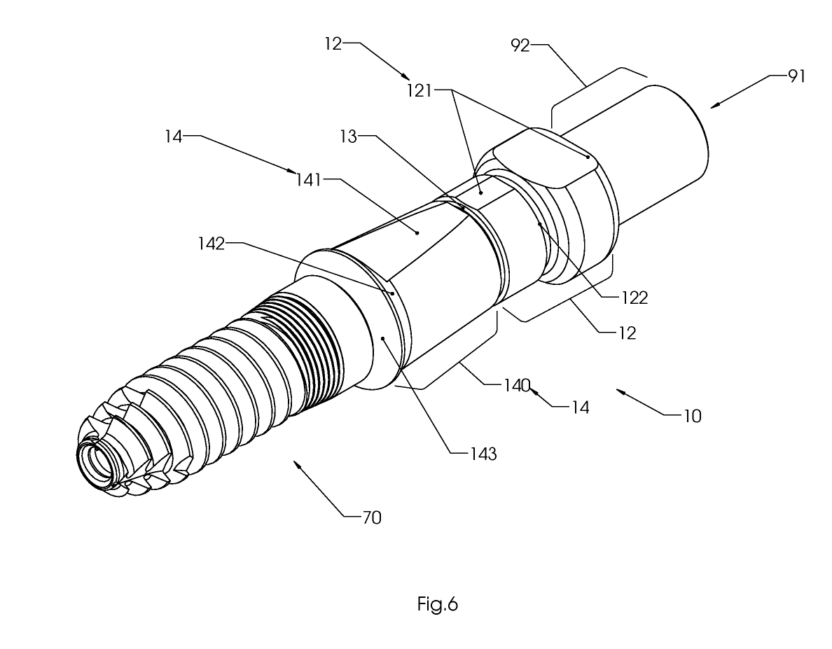

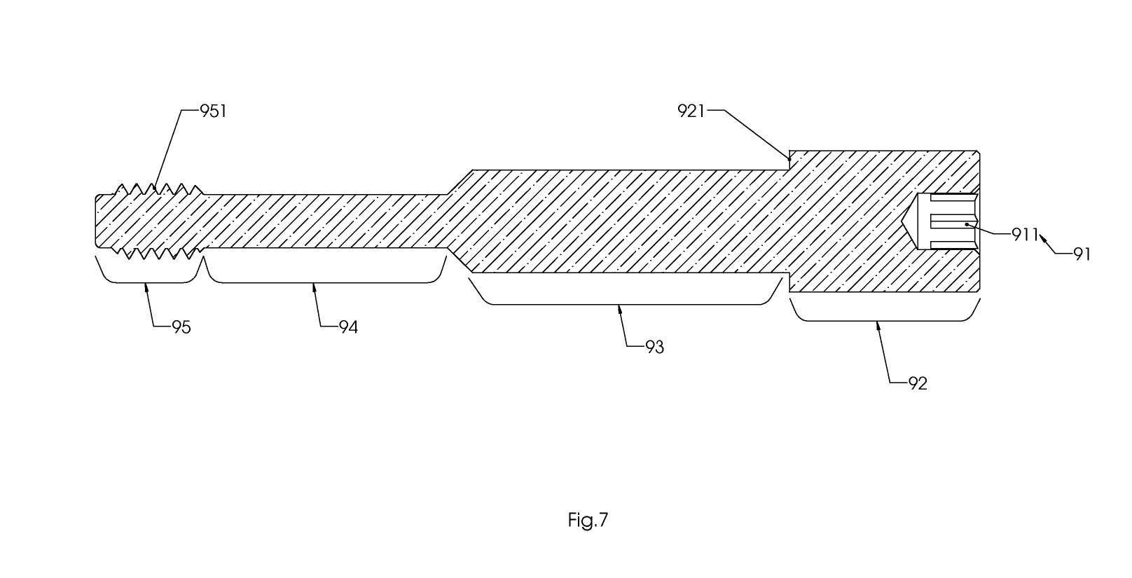

Referring to FIGS. 4 to 8 of the drawings, the threaded retentive shank (TRS) 90, according to a preferred embodiment of the present invention, is illustrated, wherein the TRS 90 comprises a bolt 94, which is a cylinder body, an apical end 95 consisting apical thread 951 adjacent to bolt 94 for inserting through the AA 10 into the dental implant 70, a shank 93 which is a cylinder body and a cylinder head 92 for providing additional retentive feature for the AA 10 to serve as an impression coping.

After the dental implant 70 is placed, the TRS 90 is used to connect and fasten the AA 10 onto the dental implant 70. The cylinder head 92 of the TRS 90 remains atop of the driven channel 112 of the AA 10.

Referring to FIGS. 4 to 7, the cylinder head 92 of the shank 93 comprises a cylinder head 92, and a hexagonal concavity 91. The cylinder head 92 comprises a step 921 adjacent to the shank 93 which allows the cylinder head 90 of the TRS 90 sit on the AA 10 and prevents AA 10 from movement of any direction.

The cylinder head 92 has a cylinder shape and is larger in diameter than the adjacent shank 93. In other words, there is a step 921 located between the cylinder head 92 and shank 93. During the utilization of open tray technique, the step can dramatically increase the stability of AA 10, and cylinder head, which is larger in diameter, makes it more convenient for dentists to locate its position.

In summary, the ankylos attachment complex 1 (AAC) which includes the ankylos attachment 10 (AA) and threaded retentive shank 90 (TRS) is specifically designed for the purpose of immediate implant placement, immediate impression and to enhance the accuracy of CAM/CAM technique. The new design employs several modern concepts in order not only to enhance the primary stability but also to provide multiple applications of an implant fixture mount. Utilizing the new designed AA 10 coupled with the TRS 90, the clinician can use closed tray technique or open tray technique to take an immediate final impression right after implant placement. Otherwise clinician can use CAD/CAM technique right after implant placement to scan patient's mouth and fabricate final restoration with CNC milling machine in which case the definitive prosthesis can be delivered within the same day. Alternatively, an acrylic shell can be fabricated before the surgery and a provisional prosthesis can be fabricated and placed on the modified AA 10 to be used as a temporary abutment at chair side right after the dental implant placement. The AA 10 can also be modified and used as a permanent attachment.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An ankylos attachment (AA), comprising a transitional adapter at a coronal end, an interior hexagonal (or triangular, square, pentagonal) slot, an driven channel, an ankylos attachment body and a connector, wherein the ankylos attachment body located between transitional adapter at coronal end and the connector at apical end of said AA consists of a tapered cylinder body, a shoulder and a semi-circular tapered shoulder, wherein the connector has three engaging jaws.

2. The AA, as recited in claim 1, wherein said transitional adapter is a 2.5 mm to 7.5 mm in length coronal extension/metal collar delineated from the ankylos attachment body and separated by a circumferential groove; wherein said transitional adapter consists of an upper portion, a lower portion and a circumferential ditch.

3. The AA, as recited in claim 1, wherein said interior hexagonal (or triangular, square, pentagonal) slot is located at the internal wall of the AA and varies from 4.5 mm to 8.5 mm in length.

4. The ankylos attachment body, as recited in claim 1, wherein said tapered cylinder body is located between the circumferential groove and the shoulder, having an angle of 3° to 5° to the longitudinal axis of said AA.

5. The ankylos attachment body, as recited in claim 1, wherein said two lower flat facets are located at opposite sides of the tapered cylinder body, extending between the circumferential groove and the shoulder.

6. The ankylos attachment body, as recited in claim 1, wherein said semi-circular tapered shoulder is located between said shoulder and said connector, consisting a semi-circular surface extending inwardly from said shoulder to said connector, having an angle of 0° to 15° to the longitudinal axis of said AA.

7. The AA, as recited in claim 1, wherein said connector is a male connector located at the apical end of AA, comprising a cylinder body and three engaging jaws.

8. The connector, as recited in claim 7, wherein said three engaging jaws are located between the circumferential curvature and cylinder body of the connector, located 120° apart from each other, each of which comprising two steps adjacent to each other.

9. A threaded retentive shank (TRS), comprising a bolt which is a cylinder body, an apical end with thread, a shank and a cylinder head, wherein the shank is located between the cylinder head and the bolt.

10. The TRS, as recited in claim 9, wherein said apical end is a cylinder shape thread located at the apical portion of the TRS.

11. The TRS, as recited in claim 9, wherein said cylinder head is located at the coronal portion of the TRS, comprising cylinder head body, a step and a hexagonal concavity.
